(19) United States
(12) Patent Application Publication
(10) Pub. No.: US 2023/0028801 A1
(43) Pub. Date: Jan. 26, 2023

(54) CUTTING DEVICE FOR A KITCHEN UTENSIL

(71) Applicant: Wundermix GmbH, Garching b. München (DE)

(72) Inventor: Adrian KEUSGEN, Endingen am Kaiserstuhl (DE)

(21) Appl. No.: 17/873,507

(22) Filed: Jul. 26, 2022

(30) Foreign Application Priority Data
Jul. 26, 2021 (DE) 10 2021 119 342.7
Jul. 21, 2022 (DE) 20 2022 104 120.2

(51) Int. Cl. A47J 43/07

(52) U.S. Cl. CPC A47J 43/0722

(57) ABSTRACT

A cutting device for insertion into a pot of an electric kitchen appliance includes a lid configured to be installed on the pot, and which has a feed opening. The cutting device includes a drivable cutting disk which, in the installed state, is rotated underneath the feed opening, and an adapter having an adaption interface for a mixing knife disposed in a bottom region of the pot. The mixing knife, during operation, causes the adapter to rotate, wherein the adapter further has a shaft which, in a state of the cutting device having been inserted into the pot, extends centrally in the direction towards the lid, and which is configured for contacting the cutting disk and for transmitting the rotation of the adapter onto the cutting disk during operation. A free end of the adapter shaft is supported in a sliding manner in the lid during operation.

### CROSS-REFERENCE TO RELATED APPLICATIONS

This application is related to and claims the benefit of German Patent Application No. 10 2021 119342.7, filed on Jul. 26, 2021, and German Patent Application No. 10 2021 104 120.2, filed on Jul. 21, 2022, the contents of which are herein incorporated by reference in their entirety.

### TECHNICAL FIELD

The present disclosure relates to a cutting device, in particular for vegetables, fruit, and potatoes. The disclosure further relates to a kitchen appliance with such a cutting device.

BACKGROUND

Cutting vegetables, fruit and/or potatoes inherently entails a great deal of effort, at least if it is done using a knife. Also, electric kitchen appliances are known with which foodstuffs can be chopped, e.g. potatoes sliced. It is disadvantageous in this case that such a food processor, as an additional kitchen appliance, requires additional space in the kitchen.

### SUMMARY

The disclosure provides an alternative for known cutting devices and a kitchen appliance. In particular, the cutting device and the kitchen appliance are supposed to enable a cutting process that is as simple and quick as possible, and require little space.

This is achieved by providing a cutting device having the features of claim 1 and a kitchen appliance having the features of claim 11. Other particularly advantageous embodiments of the disclosure are disclosed by the respective dependent claims.

It must be noted that the features cited individually in the claims can be combined with each other in any technologically meaningful manner (even across the boundaries of categories, e.g. beyond the “cutting device” and the “kitchen appliance” for which protection is sought) and represent other embodiments of the disclosure. The description, in particular in connection with the figures, additionally characterizes and specifies the disclosure.

It is also noted that a conjunction “and/or” used hereinafter, which is situated between two features and links them to each other, should always be interpreted such that, in a first embodiment of the subject matter according to the disclosure, only the first feature may be provided, in a second embodiment of the subject matter according to the disclosure, only the second feature may be provided, and in a third embodiment of the subject matter according to the disclosure, both the first and the second feature may be provided.

Further, a term “about” used herein is supposed to specify a tolerance range which the person skilled in the art working in the present field considers to be common. In particular, the term “about” is to be understood to mean a tolerance range of the quantity concerned of up to a maximum of +/−20%, preferably up to a maximum of +/−10%.

According to the disclosure, a cutting device for insertion into a pot of an electric kitchen appliance (e.g. the kitchen appliance Thermomix® 5, 6 and 31) has a lid, which can be installed on the pot of the electric kitchen appliance, wherein the lid itself has a feed opening. The cutting device further has a drivable cutting disk which, in the installed state, can be rotated (or rotates during the operation of the kitchen appliance) underneath the feed opening. Furthermore, the cutting device has an adapter, which in turn has an adaption interface for a mixing knife disposed in a bottom region of the pot of the kitchen appliance. The mixing knife causes the adapter to rotate (turn) during the operation of the kitchen appliance. The adapter further has a shaft which, in a state of the cutting device having been inserted into the pot, extends centrally in the direction towards the lid. The shaft is configured for contacting the cutting disk and for transmitting the rotation of the adapter onto the cutting disk during the operation of the kitchen appliance, wherein a free end of the shaft of the adapter is supported in a sliding manner in the lid during the operation of the kitchen appliance.

In the state of the cutting device having been inserted into the pot, the central extension of the shaft of the adapter in the direction towards the lid preferably relates to a bottom surface facing towards the lid.

The cutting device is suitable for use as an insert in a kitchen appliance. It permits the user to cut potatoes or certain types of vegetable, but also fruit, in the kitchen appliance, in particular into geometrically defined pieces. In the process, the cutting material is fed via the feed opening in the lid onto the modular cutting disk. The cutting disk is installed on the adapter. The adapter establishes the connection with drive means of the kitchen appliance, e.g. via a cutting means or a mixing knife, and transmits the rotation of the cutting means onto the cutting disk.

In the process, the cutting means first transmits the torque onto the adapter via at least one adaption interface or contact surface in the bottom of the adapter. In the process, the cutting device is supported during cutting on the mixing knife in the region of the adaption interface.

In addition, the adapter has a shaft, preferably made of stainless steel or plastic, which, in relation to a bottom surface facing towards the lid, extends centrally in the direction towards the lid, and with which the cutting disk is also driven. In this case, the free end of the shaft may preferably be supported in a sliding manner in the lid, and thus extends through the cutting disk.

In the installed state (of the lid on the pot of the kitchen appliance), the cutting material collects in the pot between the adapter and the cutting disk during cutting. For this purpose, the adapter may have a collecting section on which the cutting material collects and rests. In the installed state (of the lid on the pot of the kitchen appliance), i.e. preferably during cutting, the adapter covers the mixing knife. The cutting material resting on the adapter (the collecting section) in this case rotates at the same speed as the cutting disk. Thus, the cutting material that is transported into the intermediate space and falls down is treated particularly gently.

By means of a feeding aid, the material to be cut can be pressed from above through the feed opening onto the cutting disk. The feeding aid may be configured like a plunger.

The cutting device preferably has a central opening with which it can be placed on a free end of a drive shaft of the kitchen appliance, or receives the free end of the drive shaft. The cutting tools (of the mixing knife) are also mounted on this drive shaft and are driven by it. In a particularly advantageous embodiment, the central opening is surrounded by the shaft extending (upwards) in the direction towards the lid and is closed towards the lid, so that the free end of the drive shaft cannot come into contact with the cutting material.

The adapter and the cutting disk may have a diameter adapted to the pot of the electric kitchen appliance. Preferably, the collecting section is configured to be circular and has a diameter that, in the inserted state, makes it possible for an outer edge of the collecting section to contact an inner wall of the pot.

In a particularly advantageous embodiment, the cutting device is compatible with the kitchen appliances Thermomix® 5, 6 and 31.

According to another preferred embodiment, the adaption interface has at least two contact surfaces between which drive means, e.g. the cutting means or the mixing knife, of the kitchen appliance extend in the installed state.

In yet another embodiment, there is provided, facing towards the lid, a positioning aid visible to a user, which in the installed state is in alignment with the drive means, e.g. the cutting means or the mixing knife, of the kitchen appliance.

According to another aspect of the disclosure, a kitchen appliance has a pot, a rotatable mixing knife disposed in a bottom region of the pot, and a cutting device according to any one of the embodiments disclosed herein, wherein the mixing knife of the kitchen appliance causes the adapter of the cutting device to rotate in the installed state and during the operation of the kitchen appliance. In this case, the cutting device is inserted in the kitchen appliance. Accordingly, the kitchen appliance can be used for several tasks, i.e. on the one hand for the task originally assigned to the kitchen appliance and now, additionally, also for the task provided by the cutting device according to the disclosure.

It is noted that, with regard to kitchen appliance-related definitions of terms and the effects and advantages of features of the kitchen appliance, reference may made in full to the disclosure of corresponding definitions, effects and advantages of the cutting device according to the disclosure and vice versa. This means that disclosures contained herein regarding the cutting device according to the disclosure may also be used, mutatis mutandis, for defining the kitchen appliance according to the disclosure unless expressly excluded herein. Also, disclosures contained herein regarding the kitchen appliance according to the disclosure may also be used, mutatis mutandis, for defining the cutting device according to the disclosure unless also expressly excluded herein. Thus, a repetition of explanations of features that are basically the same, their effects and advantages may be largely omitted herein for the sake of a more compact description, without such omissions having to be interpreted as limitations for the respective subject matter of the disclosure.

According to another preferred embodiment, the mixing knife extends between two contact surfaces associated with the adapter, wherein the contact surfaces provide the adaption interface.

Preferably, the kitchen appliance has a drive shaft with a free end, on which a central opening of the cutting device is placed.

### BRIEF DESCRIPTION OF THE DRAWINGS

Other advantages and features of the disclosure become apparent from the following description of exemplary embodiments of the disclosure, which shall be understood not to be limiting and which will be explained below with reference to the drawing. In this drawing, the Figures schematically show:

FIG. 1 a exploded perspective view of an exemplary embodiment of a cutting device according to the disclosure in a synopsis with an exemplary embodiment of a kitchen appliance according to the disclosure,

FIG. 2 a sectional view of the cutting device and the kitchen appliance of FIG. 1,

FIG. 3 an oblique perspective view from above onto the cutting device of FIG. 1,

FIG. 4 an oblique perspective view from below onto the cutting device of FIG. 1,

FIG. 5 a bottom view of the cutting device of FIG. 1,

FIG. 6 a perspective view from above onto an exemplary embodiment of an adapter of the cutting device of FIG. 1, and

FIG. 7 a side view of the adapter of FIG. 6.

### DETAILED DESCRIPTION OF THE DRAWINGS

In the various figures, parts that are equivalent with respect to their function are always provided with the same reference numerals, so that they are also only described once, as a rule.

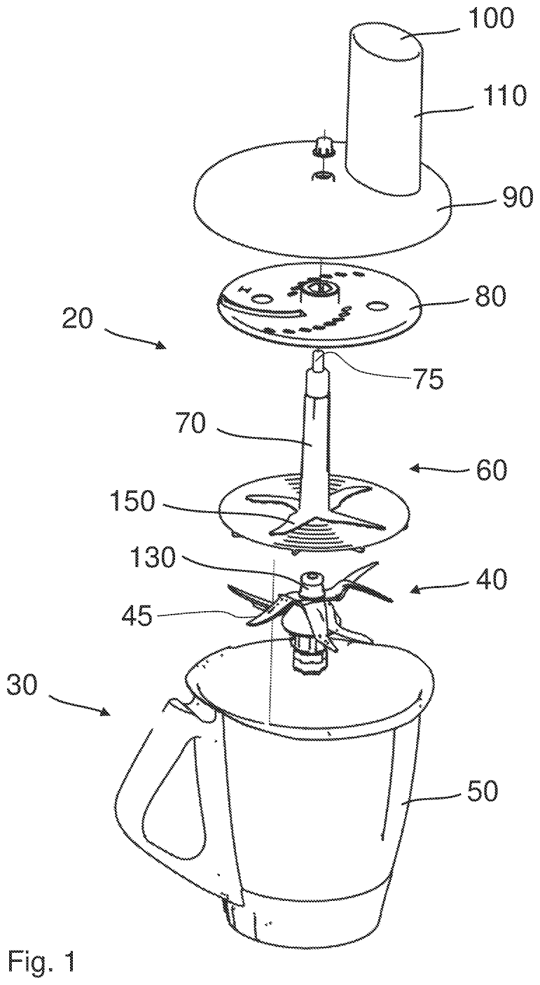

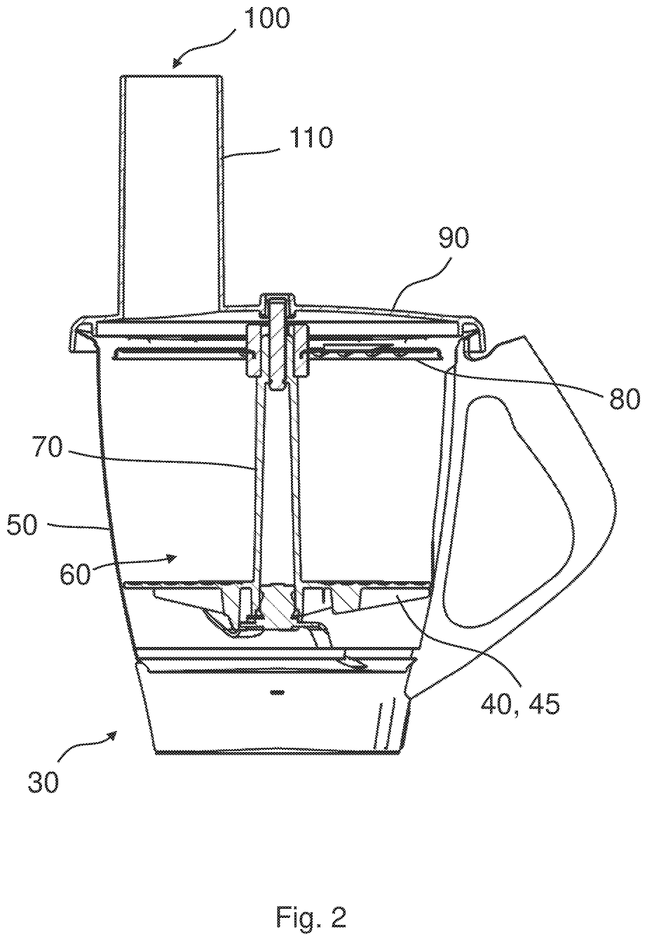

A preferred exemplary embodiment of the disclosure is illustrated in the attached Figures. FIGS. 1 and 2 show an exemplary embodiment according to the disclosure of a cutting device 20 in a synopsis with an exemplary embodiment of a kitchen appliance 30 according to the disclosure, with which the cutting device 30 can be used. Visible is a mixing knife 40 disposed within a pot 50 in the bottom region of the kitchen appliance 30.

The cutting device 20 has an adapter 60 with a shaft 70, a cutting disk 80 and a lid 90 with a feed opening 100. By means of a feeding aid 110, the material to be cut can preferably be pressed from above onto the cutting disk 80. The cutting material can collect on a collecting section 160 of the adapter 60. The collecting section 160 rotates with the adapter 60. The lid 90 is configured so that it can be separated from the adapter 60. In the exemplary embodiment shown, the free end 75 of the shaft 70 has a polygonal portion for torque transmission, which extends into a corresponding opening of the also detachable cutting disk 80.

With respect to a bottom surface facing towards the lid 90, the shaft 70 extends centrally towards the lid 90.

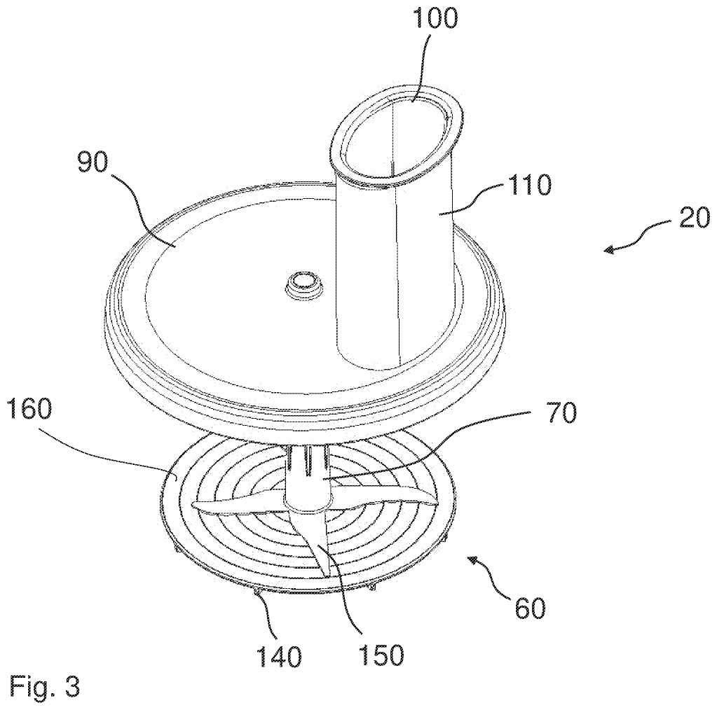

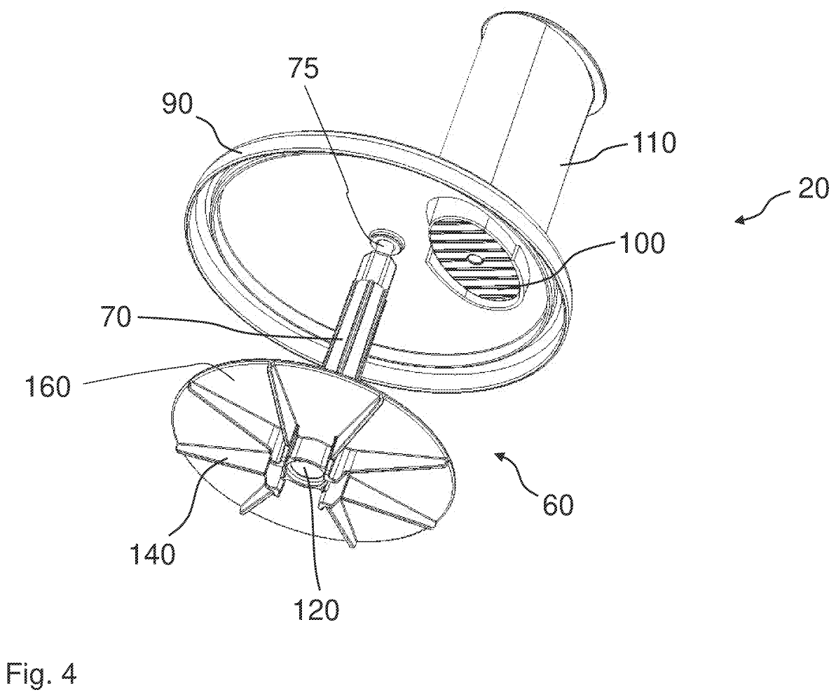

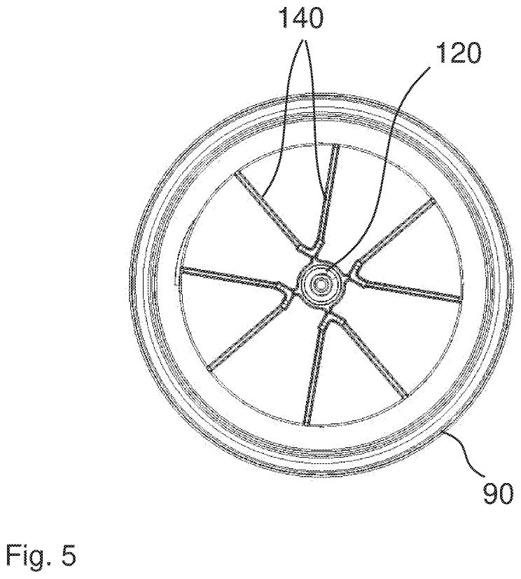

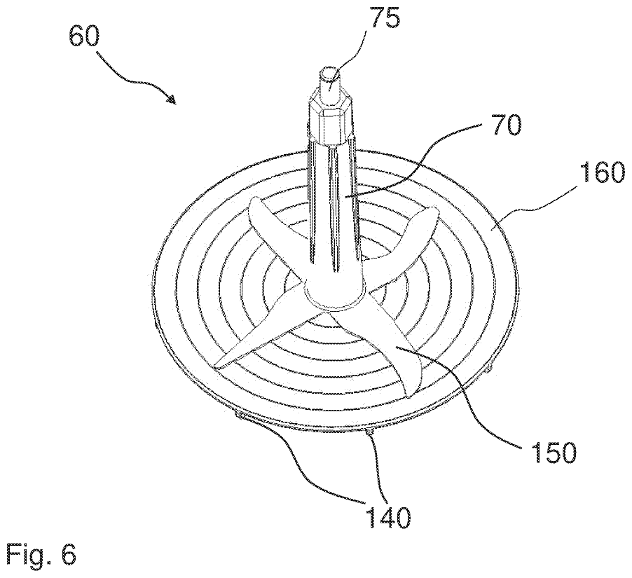

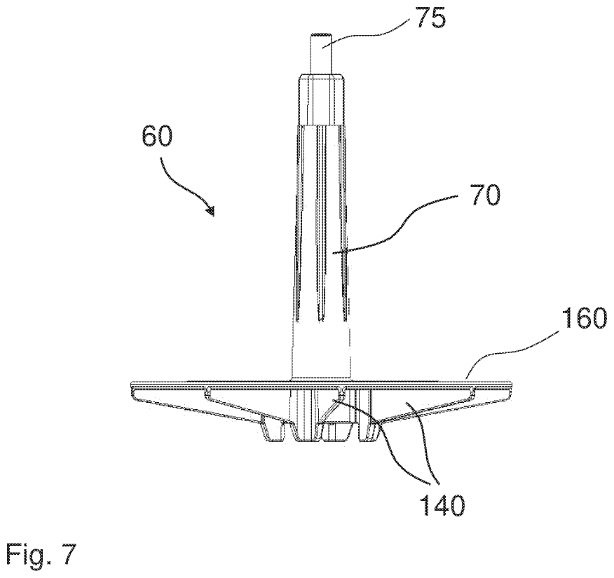

FIGS. 3 and 5 show the cutting device 20 in different views (FIG. 3 in a perspective view from above, FIG. 4 in a perspective view from below, FIG. 5 from below). FIGS. 6 and 7 only show the adapter 60.

Particularly FIG. 4 shows a central opening 120 for receiving the free end of a drive shaft 120 shown in FIGS. 1 and 2. The opening 120 is surrounded by the shaft 70.

In FIG. 4, the cutting device 20 can be seen from below. What is shown is, in particular, the centrally disposed opening 120 or receiving portion for the free end of the drive shaft 130 and the contact surfaces 140 for the radially extending cutting tools 45 of the mixing knife 40 (see FIGS. 1 and 2). Of the exemplary eight contact surfaces shown in FIG. 4, only one is labeled with 140. The cutting tools 140 of the mixing knife 40 each extend between two contact surfaces 130, so that an operation in both directions of rotation is possible.

A positioning aid 150, which is arranged on the adapter 60 and visible to the user from above, is apparent in FIGS. 3 and 6. The adapter 60 is supposed to be installable on a mixing knife located on the bottom of the pot of the electric kitchen appliance 30, in such a way that it is in alignment with the positioning aid 150. This considerably simplifies the proper insertion of the cutting device 20.

The exemplary embodiment shown in the Figures is to be understood only as an example and may also be configured differently. In particular, the cutting device according to the disclosure and the kitchen appliance disclosed herein are not limited to the specific embodiments respectively described herein, but also include further embodiments having the same effects, which result from technically viable other combinations of the features of all subject matters described herein. The features and combinations of features mentioned above in the general description and the description of the Figures and/or shown in the Figures alone can be used not only in the combinations explicitly specified herein, but also in other combinations or on their own, without departing from the scope of the present disclosure.

1. A cutting device for insertion into a pot of an electric kitchen appliance, comprising:
a lid, configured to be installed on the pot of the electric kitchen appliance, and which has a feed opening,
a drivable cutting disk, in an installed state, is configured to be rotated underneath the feed opening, and
an adapter comprising an adaption interface for a mixing knife disposed in a bottom region of the pot of the kitchen appliance, wherein the mixing knife, during the operation of the kitchen appliance, causes the adapter to rotate, wherein the adapter further has a shaft which, in an inserted state of the cutting device having been inserted into the pot, extends centrally in the direction towards the lid, and which is configured for contacting the cutting disk and for transmitting the rotation of the adapter onto the cutting disk during the operation of the kitchen appliance, wherein a free end of the shaft of the adapter is supported in a sliding manner in the lid during the operation of the kitchen appliance.

2. The cutting device according to claim 1,
wherein
the adapter, in the installed state, covers the mixing knife of the kitchen appliance.

3. The cutting device according to claim 1,
wherein
the adaption interface has at least two contact surfaces between which the mixing knife of the kitchen appliance extends in the installed state.

4. The cutting device according to claim 1,
wherein
in the installed state, cutting material collects in the pot between the adapter and the cutting disk during cutting.

5. The cutting device according to claim 4,
wherein
the collected cutting material rests on a collecting section of the adapter and rotates with the adapter.

6. The cutting device according to claim 1,
wherein
a central opening for receiving a free end of a drive shaft of the kitchen appliance is provided.

7. The cutting device according to claim 6,
wherein
the central opening is surrounded by the shaft extending in the direction towards the lid and is closed towards the lid.

8. The cutting device according to claim 1,
wherein
the collecting section is configured to be circular with a diameter such that, in the inserted state, an outer edge of the collecting section contacts an inner wall of the pot.

9. The cutting device according to claim 1,
further comprising a positioning aid visible to a user and facing towards the lid, which in the installed state is in alignment with the mixing knife of the kitchen appliance.

10. The cutting device according to claim 1,
wherein
a feeding aid is provided such that cutting material is configured to be pressed from above through the feed opening onto the cutting disk.

11. A kitchen appliance, comprising a pot and a rotatable mixing knife disposed in a bottom region of the pot,
wherein
a cutting device is configured in accordance with claim 1, wherein the mixing knife causes the adapter of the cutting device to rotate in the installed state and during operation of the kitchen appliance.

12. The kitchen appliance according to claim 11,
wherein
the mixing knife extends between two of the contact surfaces associated with the adaption interface of the adapter.

13. The kitchen appliance according to claim 10,
wherein
a drive shaft with a free end, on which a central opening of the cutting device is placed.
